(19) United States
(12) Patent Application Publication
(10) Pub. No.: US 2005/0058077 A1
(43) Pub. Date: Mar. 17, 2005

(54) Fast-path implementation for an uplink double tagging engine

(75) Inventor: Roman Mayr, Munchen (DE)

Correspondence Address: MORRISON & FOERSTER LLP, 1650 TYSONS BOULEVARD, SUITE 300, MCLEAN, VA, 22102, US

(73) Assignee: Infineon Technologies AG, Munich (DE)

(21) Appl. No.: 10/878,677

(22) Filed: Jun. 29, 2004

(30) Foreign Application Priority Data
Jun. 30, 2003 (DE) 103 30 042.2

(51) Int. Cl. H04L 1/00

(52) U.S. Cl. 370/241

(57) ABSTRACT

A semi-conductor component test procedure, as well as a system for testing semi-conductor components.

The invention relates to a semi-conductor component test procedure, as well as a system for testing semi-conductor components (3a, 3b, 3c, 3d), by means of a first and a second test apparatus (6a, 6b), whereby the first test apparatus (6a) is arranged and installed such that a time-discrete semi-conductor component test is performed by it on a particular semi-conductor component (3a), and whereby the second test apparatus (6a) is arranged and installed such that a separate, time-continuous semi-conductor component test is performed by it on the same semi-conductor component (3a).

### CLAIM FOR PRIORITY

This application claims priority to German Application No. 103 30 042.2 filed Jun. 30, 2003, which is incorporated herein, in its entirety, by reference.

### TECHNICAL FIELD OF THE INVENTION

The present invention relates to a method and apparatus for processing a packet based on a double tagging engine within a Virtual Private LAN Service (VPLS), a Transparent LAN Service (TLS), a Virtual Private Switched Network Service (VPSNS), or any Layer 2 Virtual Private Network (VPN).

### BACKGROUND OF THE INVENTION

As the popularity and usage of networked computers grows, an increasing amount of end-users are being interconnected via wide area networks and the Internet. In particular, business entities, such as corporations, having multiple site-offices located in different parts of the world, are increasingly relying on the Internet to communicate with each other. For instance, a corporate entity having multiple site-offices located at geographically dispersed sites may look to a fast and efficient way using the Internet to interconnect a group of private site-offices belonging to the private corporate entity together. Accordingly, there is a need to provide a fast, inexpensive and reliable system that can offer a virtual private customer-based network wherein inter-office network connections are achieved using the fast growing Internet infrastructure, especially the Internet Service Provider (ISP).

Description

A semi-conductor component test process, as well as a system for testing semi-conductor components.

The invention relates to a semi-conductor component test process, as well as a system for testing semi-conductor components.

Semi-conductor components, for instance corresponding integrated (analog and/or digital) computing circuits, semi-conductor memory components, for instance functional memory components (PLAs, PALs, etc.) and table memory components (e.g. ROMs or RAMs, in particular SRAMs and DRAMs) are subjected to extensive testing during the manufacturing process.

For the simultaneous manufacture of numerous (generally identical) semi-conductor components, a so-called wafer (i.e. a thin disk of monocrystalline silicon) is used. The wafer is appropriately treated (for instance subjected in succession to numerous coating, exposure, etching, diffusion and implantation process steps, etc.), and then for instance sliced up (or scored and snapped off), so that the individual components become available.

During the manufacture of semi-conductor components (for instance DRAMs (Dynamic Random Access Memories and/or dynamic read-write memories), in particular of DDR-DRAMs (Double Data Rate—DRAMs and/or DRAMs with double data rate)) semi-completed components (still on the wafer) can be subjected—even before the above process steps required for the wafer have been completed (i.e. even while the semi-conductor components are still in a semi-complete state)—to appropriate test processes (for instance so-called kerf measurements at the wafer scoring frame) with the aid of one or more test apparatuses.

After their completion, (i.e. after completion of all the above wafer processing steps) the semi-conductor components are subjected to further test procedures at one or more (further) test stations where completed components—still on the wafer—can for instance be appropriately tested with the aid of corresponding (additional) test equipment (“slice tests”).

After the wafers have been sliced up (and/or scored and snapped off), the—individually available—components are then each loaded onto so-called carriers (i.e. a suitable mounting), whereupon the semi-conductor components—loaded into the carriers—can be subjected to one or several (further) test procedures corresponding to other test stations.

In the same fashion one or more further tests (at corresponding further test stations and with the use of appropriate additional test equipment) can be performed, for instance after the semi-conductor components have been mounted into the corresponding semi-conductor component housing, and/or for instance after the semi-conductor component housing (together with the semi-conductor components mounted onto it in each case) has been mounted into a corresponding electronic module (for so-called module tests).

For performing the above test procedure (e.g. a corresponding module test procedure, slice test procedure, etc.) appropriate digital data (“ones”, and/or “zeros”) can be stored by the test apparatus in question in the corresponding semi-conductor component to be tested—by applying voltages of an appropriate value to corresponding semi-conductor component connections—and later read back again by the test apparatus in question.

The read-out data (“ones”, and/or “zeros”)—embodied in the signals emitted to corresponding connections during the reading of the semi-conductor component in question—are inspected by the test apparatus in question to see if it corresponds with the above-digital-data entered into the semi-conductor component and stored there (e.g. whether a “one” entered and stored is emitted-correctly-as a “one” (or-incorrectly-as a “zero”), or whether a “zero” entered and stored is-correctly-emitted as a “zero” (or-incorrectly-as a “one”))( so-called “logic test” and/or “time-discrete digital functionality test”).

Furthermore, the above test apparatus—additionally and simultaneously—examines the above signal emitted at corresponding connections of the semi-conductor components during the reading of the (digital) data for its integrity and/or quality (so-called “time-continuous analog signal integrity and/or quality test”).

Thereby the chronological displacement (skew) occurring between individual read-out data and/or data strobes, and/or scanning degree and/or pulse duty ratio (pulse interval to pulse duration) distortions (DCD, duty cycle distortion), and/or interference between individual data symbols (ISI, inter-symbol interference), and/or jitters (i.e. the variation of the above signals around ideal-equidistant-instants)—can be measured, for instance by a corresponding evaluation of the signal eye, etc, etc.

With the help of the above test procedure, defective components and/or semi-conductor components falling outside the required quality standards can be identified and removed (or to a certain extent repaired).

The invention is aimed at making available a novel semi-conductor component test procedure, as well as a novel test system for testing semi-conductor components.

These and other objects are achieved by means of the subject matters of Claims 1 and 6.

Advantageous further developments of the invention are listed in the subsidiary claims.

In terms of a basic concept of the invention a system for testing semi-conductor components is made available, which contains a first and a second test apparatus, whereby the first test apparatus is so arranged and installed that a time-discrete semi-conductor component test is performed by it on a particular semi-conductor component, and whereby the second test apparatus is so arranged and installed that a separate, time-continuous semi-conductor component test—on the same semi-conductor—component is performed by it.

Advantageously, during the time-discrete semi-conductor component test, only the functionality of the semi-conductor is tested (for instance by comparing bits or bit sequences received from the semi-conductor component with reference bits or bit sequences), and during the time-continuous semi-conductor component test, the integrity and/or quality of the signals emitted by the semi-conductor component.

Below, the invention is more closely described by means of an embodiment example and the attached illustrations. In the illustrations:

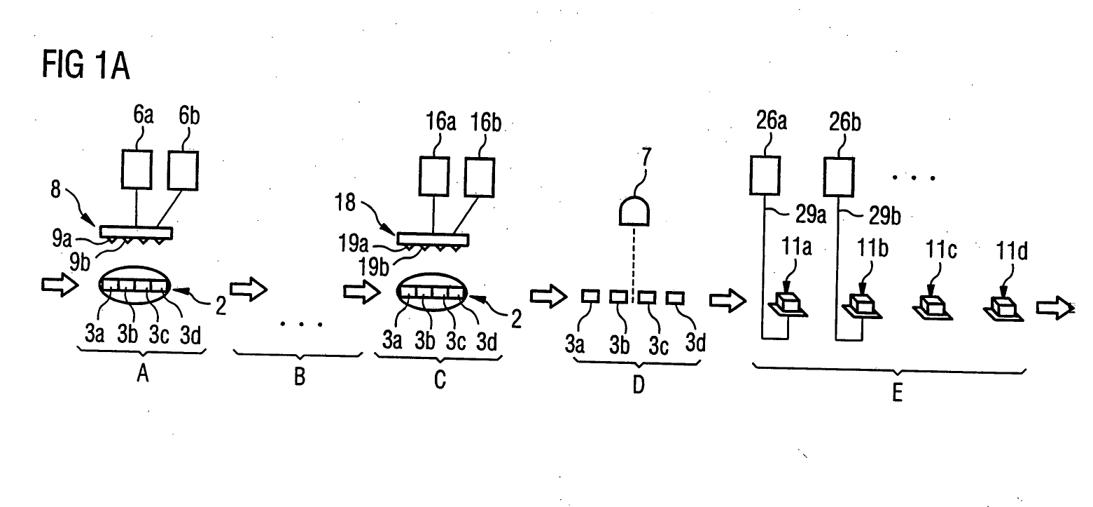

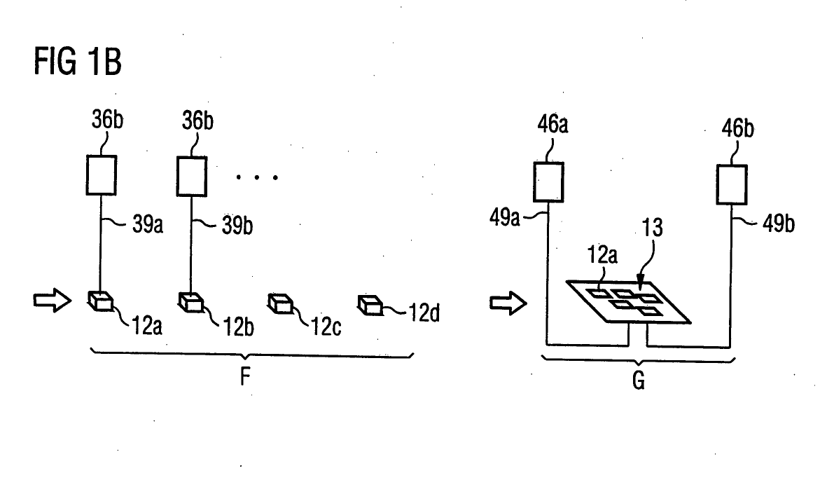

FIG. 1a shows a schematic representation of the stations that are passed through during the manufacture of corresponding semi-conductor components, and several test apparatuses forming part of a semi-conductor component testing system; and

FIG. 1b shows a schematic representation of further stations passed through during the manufacture of corresponding semi-conductor components, and several further test apparatuses used for testing semi-conductor components; and

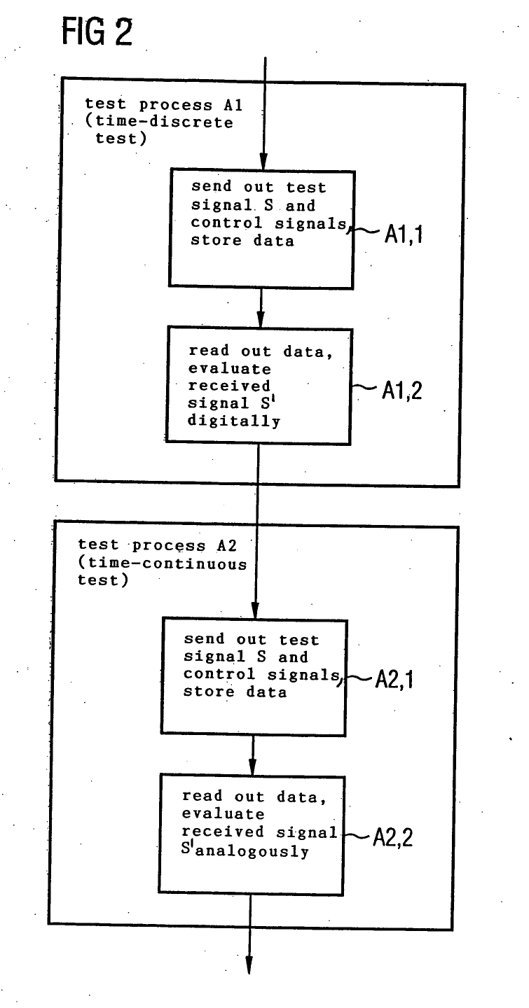

FIG. 2 shows a schematic representation of a process flow diagram to illustrate the test methodology applied in the semi-conductor component test procedure with the test apparatuses shown in FIG. 1a and/or FIG. 1b.

FIGS. 1a and 1b show—in a schematic fashion—some of the stations A, B, C, D, E, F, G (of a multitude of further stations not shown here) which during the manufacture of semi-conductor components 3a, 3b, 3c, 3d (and/or electronic modules) are passed through by the corresponding semi-conductor components 3a, 3b, 3c, 3d.

The semi-conductor components 3a, 3b, 3c, 3d may for instance be corresponding integrated (analog and/or digital) computing circuits, and/or semi-conductor memory components, for instance functional memory components (i.e. PLAs, PALs, etc.), and table memory components, (for instance ROMs or RAMs), in particular SRAMs or DRAMs (here for instance DRAMs (Dynamic Random Access Memories and/or Dynamic Read-Write Memories) with double data rate (DDR DRAMs=Double Data Rate−DRAMs), preferably high-speed DDR DRAMs).

During the manufacture of the semi-conductor components 3a, 3b, 3c, 3d, an appropriate silicon disk or an appropriate wafer 2 is subjected to corresponding conventional coating, exposure, etching, diffusion, and/or implantation process steps, etc.—for instance at corresponding stations placed in series upstream and downstream from the station A shown in FIG. 1a (for instance, station B placed after station A)—as well as at numerous further stations—not shown here—(placed before and after station A).

Station A serves—as is more closely described below—to subject the semi-conductor components 3a, 3b, 3c, 3d—still present on wafer 2—to two or more test procedures (test procedure A1 and/or test procedure A2 and/or test procedure A3, etc.) by means of two or more test apparatuses 6a and 6b (or alternatively by a single test apparatus)(and as is apparent from the embodiment examples above—even before all the above process steps required for wafer 2 have been completed (i.e. already during the half-completed state of the semi-conductor components 3a, 3b, 3c, 3d)).

The voltages/currents and/or test signals required at station A for testing the semi-conductor component 3a on wafer 2, are generated—as is more closely described below—by the corresponding test apparatuses 6a, 6b, and fed to corresponding connections of the semi-conductor component 3a, by means of the semi-conductor component probecard (test card) 8, which is connected to the test apparatuses 6a, 6b (more precisely: by means of corresponding contact pins 9a, 9b provided on the probecard 8).

From station A, wafer 2 is (in particular fully automatically) transported to station B (and from there to numerous further possible stations—not shown here), where—as already mentioned above—wafer 2 is subjected to further appropriate process steps (in particular to appropriate coating, exposure, etching, diffusion, and/or implantation process steps, etc.), and/or to further test procedures—correspondingly similar to those applied at station A.

After the semi-conductor components have been completed (i.e. after all the above wafer processing steps have been performed), wafer 2 is transported from the corresponding—previous—processing station (for instance from station B, or other further—downstream—stations)—in particular completely automatically—to the next station C. Station C serves—as is more closely described below—to subject the semi-conductor components 3a, 3b, 3c, 3d—completed and still present on the wafer 2—to various—additional—test procedures for instance by means of two or more test apparatuses 16a, 16b (or alternatively by means of a single test apparatus)(test procedure C1, and/or test procedure C2, and/or test procedure C3, etc) for instance to so-called slice tests.

The voltages/currents and/or test signals required at station C for testing the semi-conductor component 3a on the wafer 2, are generated—as is more closely described below—by the test apparatuses 16a, 16b and fed by means of a semi-conductor component test card and/or probecard 18 connected to the test apparatuses 16a, 16b to the corresponding connections of the semi-conductor component 3a (more precisely: by means of corresponding contact pins 19a, 19b provided on probecard 18).

From station C, wafer 2 is (in particular fully automatically) transported to the next station D, where (after wafer 2 has had foil glued to it in a recognized fashion) it is sliced up by means of an appropriate machine 7 (or for instance scored and snapped off), so that the semi-conductor components 3a, 3b, 3c, 3d then become—individually—available.

Before being transported to station D, wafer 2—and/or the components 3a, 3b 3c, 3d present on it—may be subjected to one or more further test procedures—corresponding with station C—at one or several stations.

After wafer 2 has been sliced up at station D, each individual component 3a, 3b, 3c, 3d is then (particularly—again—fully automatically) loaded into a corresponding carrier 11a, 11b, 11c, 11d and/or corresponding holder 11a, 11b, 11c, 11d, whereafter the semi-conductor components 3a, 3b, 3c, 3d—loaded into carriers 11a, 11b, 11c, 11d13 are transported to one or several (further) test stations—for instance to the station E shown in FIG. 1a—and subjected to one or more further test procedures (test procedure E1, and/or test procedure E2, and/or test procedure E3, etc.), for instance to the so-called carrier tests.

For this, a corresponding carrier 11a is inserted into a corresponding carrier socket and/or carrier adapter—which is connected to two or more test apparatuses 26a, 26b (or alternatively for instance to a single test apparatus) via corresponding lines 29a, 29b.29d (and the remaining carriers 11b, 11c, 11d for instance into further carrier sockets and/or carrier adapters connected to further test apparatuses not shown here).

The voltages/currents and/or test signals required at station E for testing a corresponding semi-conductor component 3a in a corresponding carrier 11a, are generated—as is more closely described below—by the test apparatuses 26a, 26b and fed—via the lines 29a, 29b, the carrier socket connected to them, and the carrier 11a linked to it—to corresponding connections on the semi-conductor component 3a.

From station E the semi-conductor components 3a, 3b, 3c, 3d are further transported (in particular completely automatically) to one or more station(s)—not shown here—where the semi-conductor components 3a, 3b, 3c, 3d are mounted into the corresponding housings 12a, 12b, 12c, 12d (for instance corresponding plug-in or surface-mounted component housings, etc.).

As shown in FIG. 1b, the semi-conductor components 3a, 3b, 3c, 3d—mounted into housings 12a, 12b, 12c, 12d—are then further transported to one (or more) further test stations—for instance to the station F shown in FIG. 1b—and subjected to one or more further test procedures there (test procedure F1, and/or test procedure F2, and/or test procedure F3, etc.).

For this a corresponding semi-conductor component housing 12a is inserted into a corresponding component housing socket and/or component housing adapter connected—via corresponding lines 39a, 39b with two (or more) corresponding test apparatus(es) 36a, 36b (or alternatively for instance to a single test apparatus)(and the remaining semi-conductor component housings 12b, 12c, 12d correspondingly inserted into further component housing sockets and/or component housing adapters—connected to further test apparatuses not shown here).

The voltages/currents and/or test signals required at station F for testing a corresponding semi-conductor component 3a—mounted in a corresponding housing 12a—are generated—as is more closely described below—by the above test apparatuses 36a, 36b and fed via the lines 39a, 39b, connected to the housing sockets and the test apparatus(es) 36a, 36b and the component housings 12a, 12b connected to it, to corresponding connections on the semi-conductor component 3a.

From station F the semi-conductor components 3a, 3b, 3c, 3d mounted in the housings 12a, 12b, 12c, 12d can then—optionally—be transported to one or more further stations—not shown here—where a corresponding semi-conductor component housing (for instance the housing 12a, with the semi-conductor component 3a mounted in it)—together with further components (analog and/or digital computer circuits, and/or semi-conductor memory components, for instance PLAs, PALs, ROMs, RAMS, in particular SRAMs or DRAMs, etc.)—is connected to a corresponding electronic module 13—for instance a circuit board.

As shown in FIG. 1b, the electronic module 13 (and thereby also the semi-conductor components 3a (mounted in a corresponding housing 12a)—connected to the electronic module 13) can then—optionally—be transported further to one (or more) further test stations—for instance the station G shown in FIG. 1b—and there subjected to one or more further test procedures (test procedure G1, and/or test procedure G2, and/or test procedure G3, etc.)—in particular to so-called module tests.

The voltages/currents and/or test signals required at station G for testing the module 13 (and thereby also the semi-conductor component 3a (and/or further components) mounted in it) are for instance generated—as is more closely described below—by several test apparatuses, for instance two or more test apparatuses 46a, 46b (or alternatively by a single test apparatus) and fed via corresponding lines 49a, 49b to the electronic module 13, and thereby also to the corresponding connections of the corresponding semi-conductor component 3a (and/or the remaining components) mounted in it.

As more closely described below—with the example of the test station A shown in FIG. 1a, and the test apparatuses 6a, 6b provided there—a special test methodology, schematically represented in the process diagram as shown in FIG. 2, can be applied in the present embodiment example of the invention during the application of the above test procedure (and in fact not only—here illustrated as an example—at test station A, and the test apparatuses 6a, 6b provided there, but alternatively or additionally for instance also at the test station C, and the test apparatuses 16a, 16b provided there, and/or at the test station E, and the test apparatuses 26a, 26b provided there, and/or at the test station F, and the test apparatuses 36a, 36b provided there, and/or at the test station G, and the test apparatuses 46a, 46b provided there, etc.).

As is apparent from FIG. 2, in the embodiment example shown here a single, conventional functionality and signal integrity test—for one and the same semi-conductor component 3a—is split into two separate, in particular successively performed procedures, in fact a time-discrete test procedure (here: the above test procedure Al (“logic test” and/or the “time-discrete digital functionality test”)), and a continuous test procedure (here: the above test procedure A2 (“continuous analog signal integrity and/or quality test”)).

To perform test procedure A1, (i.e. the above time-discrete functionality test) digital data (“ones”, and/or “zeros”, i.e. corresponding bits or bit sequences)(and by means of appropriate control signals, for instance a clock pulse, and/or a write command signal, etc.), is for instance transferred by means of a digital test signal S sent out by test apparatus 6a and transferred via the probecard 8 and its corresponding probecard contact pins 9a to the corresponding semi-conductor component 3a to be tested and stored there—under the control of the above control signal—in corresponding memory cells to be tested (for instance several or all the memory cells in a corresponding memory cell array) (cf. also the—first—process step A1 shown in FIG. 2).

The sending out and/or storage of data can for instance be done at the maximum data rate and/or clock frequency f1 allowed in each case by the test apparatus and/or the semi-conductor component 3a (for instance at between 400 MHz and 1200 MHz, in particular for instance between 600 MHz and 1000 MHz), or—alternatively—for instance at a data and/or clock frequency f1′reduced in relation to the maximum data rate and/or clock frequency f1 (for instance at between 50 MHz and 400 MHz).

Then the test apparatus 6a—by sending out corresponding further control signals (for instance a clock pulse, and/or a read-instruction signal, etc.), which are transferred via the probe card 8 and corresponding probe card contact pins 9a to corresponding connections of the semi-conductor component 3a to be tested in each case—causes the—digital—data (bits and/or bit sequences), previously stored in the semi-conductor component 3a to be tested during step A1,1 (and/or more correctly: in the above memory cells), to be read out again from the semi-conductor component 3a, and—by means of corresponding probe card contact pins 9a and the signal S′ transferred to the probecard 8—to be transferred to the test apparatus 6a to be evaluated there (cf. also the—second—process step A1,2 shown in FIG. 2).

The reading out and/or transmission of data to the test apparatus 6a can for instance be done at the maximum data rate and/or clock frequency f1 allowed in each case by the test apparatus and/or the semi-conductor component 3a (for instance at between 400 MHz and 1200 MHz, in particular for instance between 600 MHz and 1000 MHz), or—alternatively—for instance at a data and/or clock frequency f1′reduced in relation to the maximum data rate and/or clock frequency f1 (for instance at between 50 MHz and 400 MHz).

In the evaluation of the data (bits and/or bit sequences)—transferred via signal S′—in the test apparatus 6a, it is simply verified whether this data corresponds with the above—digital—data (bits and/or bit sequences) transferred by means of test signal S to the semi-conductor component 3a and stored there—or not (for instance by verifying by means of a test comparator provided in test apparatus 6a, whether a “one” stored in a corresponding memory cell of the semi-conductor component 3a with the help of the above test signal S is correspondingly—correctly—emitted as “one” (or—correspondingly incorrectly—as “zero”) via the above signal S′, and/or whether a “zero” stored in a corresponding memory cell of the semi-conductor component 3a with the help of the above test signal S is emitted—correctly—as “zero” (or—incorrectly—as “one”)(“logic test” and/or “time-discrete digital functionality test”)).

For this, the signal S′ can for instance be scanned at preset (determined by the above clock frequency f1) reference instants, and depending on whether the signal value of the signal S′ measured in each case lies above or below a critical value (and/or above an upper, or below a lower critical value (upper and/or lower discriminator-critical value)), it can be detected that a “one” or a “zero” has been read from the corresponding memory cell.

For the test procedure A1 only the signals used to stimulate the semi-conductor component 3a (i.e. the signals emitted at the first test step A1,1 to semi-conductor component 3a (for instance the above test signal S, and/or the corresponding control signal) need to exhibit the complete level of accuracy made available by test apparatus 6a; the signal (signal S′) emitted during the second test step A1,2 by the semi-conductor component 6a is only tested with regard to functionality (e.g. time-discrete, and not continuously (see below))—e.g. not with the full accuracy made available by test apparatus 6a. Thereby the total accuracy requirements—in relation to conventional test procedures—of the test apparatus 6a can be reduced, in particular be halved (and/or the total accuracy actually achieved by test apparatus 6a (OTA or Overall Timing Accuracy) can be improved (for instance from ±60 ps to ±30 ps)).

In particular the accuracy of test apparatus 6a during the above second process step A1,2 (and/or in relation to the signal S′ emitted by semi-conductor component 3a) is essentially only affected by the so-called “equivalent rise time” of the test comparator provided in the test apparatus 6a for making the above comparison: the requirements regarding signal skew, synchronicity, etc. are—for the second process step A1,2—only relatively minor.

For the test apparatus 6a for instance a conventional semi-conductor component-test apparatus, normally used as an integrated functionality and signal integrity test apparatus, can be used, or also a special test apparatus, specially conceived for the above functionality test.

As is further illustrated in FIG. 2, a—separate—continuous test procedure (here: the above test procedure A2 (“continuous analog signal integrity and/or quality test”)) is performed—in particular before or after the time-discrete test procedure A1—and in fact advantageously by a special further test apparatus (for instance the test apparatus 6b)—separate to the above test apparatus 6a used in the time-discrete test procedure (alternatively the two test procedures A1 and A2 may also be performed—in particular successively—by one and the same test apparatus).

For the test apparatus 6b a special—analog—signal analysis measurement instrument can be used, for instance a suitable apparatus from the company WaveCrest™.

With the aid of for instance the test procedure A2 performed by test apparatus 6b—as is more closely described below—the signals emitted during the reading of (digital) data at corresponding connections of the semi-conductor component to be tested in each case (here: of the semi-conductor component 3a) are investigated for their integrity and/or quality, i.e. a continuous analog signal integrity and/or quality test is performed.

Thereby for instance the chronological offset (skew), and/or scanning degree and/or pulse duty ratio distortion (DCD or duty cycle distortion), and/or interference between individual data symbols (ISI or inter-symbol interference), and/or jitter (i.e. the fluctuation of reference instants of the above signals around ideal—equidistant—instants) occurring between individual read-out data and/or data strobes can be measured—for instance by means of a corresponding evaluation of the signal eye—etc., etc. (i.e. the read-out data is investigated for skew and/or DCD and/or ISI and/or jitter faults, etc.).

To perform test procedure A2, digital data (“ones”, and/or “zeros”, i.e. corresponding bits or bit sequences)(and by means of appropriate control signals, for instance a clock pulse, and/or a write command signal, etc.), is for instance transferred by means of a digital test signal S sent out by the—further—test apparatus 6b and transferred via the probecard 8 and its corresponding probecard contact pins 9a to the corresponding semi-conductor component 3a to be tested and stored there—under the control of the above control signal—in corresponding memory cells to be tested (for instance several or all the memory cells in a corresponding memory cell array)(cf. also the process step A2,1 shown in FIG. 2).

The sending out and/or storage of data can for instance be done at the maximum data rate and/or clock frequency f2 allowed in each case by the test apparatus and/or the semi-conductor component 3a (for instance at between 400 MHz and 1200 MHz, in particular for instance between 600 MHz and 1000 MHz), or—alternatively—for instance at a data and/or clock frequency f2′reduced in relation to the maximum data rate and/or clock frequency f2 (for instance at between 30 MHz and 300 MHz).

The test signal S and/or the control signal can be identical or essentially identical to the test signal S (and/or the corresponding control signal)—emitted during test procedure A1 at process step A1,1 by test apparatus 6a—and/or can be applied at identical connections of the semi-conductor component 3a to be tested in each case, as the test signal S (and/or the corresponding control signal) emitted during test procedure A1 in process step A1,1 by test apparatus 6a.

Alternatively the process step A2,1 can also be dispensed with (in its place, as is more closely described below, data that was—in terms of the process steps A1,1 performed during the test procedure A1—previously laid down by test apparatus 6a in the semi-conductor component 3a to perform the test procedure A2 during a process step A2,2, can be read out from the semi-conductor component 3a).

As is further shown in FIG. 2, it is caused during a process step A2,2 (for instance one following process step A2,1) for instance by means of a digital test signal S (and by means of an appropriate control signal, for instance a clock pulse, and/or a write command signal, etc.) sent out by test apparatus 6b, and transferred via the probecard 8 and its corresponding probecard contact pins 9a to the corresponding connections of the semi-conductor component 3a to be tested in each case—that digital data (bits or bit sequences) previously stored in the corresponding semi-conductor component 3a during step A2,1 (more correctly: in the above memory cells), is read out and—by means of signal S′ (in particular corresponding with signal S′ at the above process step A1,2) transferred via corresponding probecard contact pins 9a and the probecard 8—conveyed to the test apparatus 6b, and evaluated there.

The reading out and/or transfer of data to test apparatus 6b can for instance be done at the maximum data rate and/or clock frequency f2 allowed in each case by the test apparatus and/or the semi-conductor component 3a (for instance at between 400 MHz and 1200 MHz, in particular for instance between 600 MHz and 1000 MHz), or—alternatively—for instance at a data and/or clock frequency f2′reduced in relation to the maximum data rate and/or clock frequency f2 (for instance at between 30 MHz and 300 MHz).

In the evaluation of the signal S′ by the test apparatus 6b conventional continuous analog signal integrity and/or quality tests can be performed. For instance the signal S′ can be investigated for possible skew and/or DCD and/or ISI and/or jitter faults, etc.(or it can be investigated to see that corresponding skew and/or DCD and/or ISI and/or jitter faults etc. do not exceed specific pre-set maximum values).

For this the chronological offset (skew), and/or scanning degree and/or pulse duty ratio distortions (DCD or duty cycle distortions), and/or interference between individual data symbols (ISI or inter-symbol interference), and/or systematic and/or non-systematic) jitter occurring between individual, read-out data and/or data strobes can be measured—for instance by means of corresponding evaluation of the signal eye, etc., etc.

For instance the signal S′ can—in order to evaluate signal integrity and/or quality—be scanned at pre-set reference instants (determined by the above clock frequency f2), and so measured to see how far the signal value in each case lies above or below corresponding (discriminator) critical values (and thereby to evaluate whether the signal interval is large enough in every case to satisfy the signal quality demands).

The test apparatus 6b has been so arranged that corresponding continuous signals can be measured with the highest measure of chronological accuracy.

The above measurements can be performed by the above test apparatus 6b, for instance by using a signal switching matrix integrated in the test head and/or the probecard 8—for instance containing corresponding switches, in particular relays.

The signal switching matrix ensures that signals emitted by each semi-conductor component 3a are always—correspondingly dependent on whether the test procedure A1, or the test procedure A2 is to be performed—transferred to the test apparatus 6a, or to the test apparatus 6b (and/or that either the test apparatus 6a, or the test apparatus 6b is connected to each semi-conductor component 3a to be tested)—for instance thereby that the corresponding switches, in particular the relays of the signal switching matrix are correspondingly switched over.

Alternatively, the above test procedure A1 can also be performed simultaneously (by test apparatus 6a), and the above test procedure A2 (by test apparatus 6b)(for instance thereby that the signal S′ emitted by the semi-conductor component 3a to be tested in each case is—simultaneously—transferred to both the test apparatus 6a and to the test apparatus 6b (and in the test apparatus 6a the signal S′ is then—correspondingly as described above—subjected to the above time-discrete digital functionality test (test procedure A1), and in the test apparatus 6b to the above continuous analog signal integrity and/or quality test (test procedure A2)).

Reference Numbers

2 Wafer
3a Semi-conductor component
3b Semi-conductor component
3c Semi-conductor component
3d Semi-conductor component
6a Test apparatus
6b Test apparatus
7 Slicing machine
8 Probecard
9a Contact pins
9b Contact pins
11a Carrier
11b Carrier
11c Carrier
11d Carrier
12a Component housing
12b Component housing
12c Component housing
12d Component housing
13 Electronic module
16a Test apparatus
16b Test apparatus
18 Probecard
19a Contact pins
19b Contact pins
26a Test apparatus
26b Test apparatus
29a Line
29b Line
36a Test apparatus
36b Test apparatus
39a Line
39b Line
46a Test apparatus
46b Test apparatus
49a Line
49b Line

1. A system for testing semi-conductor components (3a, 3b, 3c, 3d), with a first and a second test apparatus (6a, 6b)
characterized in that
the first test apparatus (6a) is arranged and adapted such that a time-discrete semi-conductor component test is performed with it for a particular semi-conductor component (3a) and that the second test apparatus (6a) is arranged and adapted such that a separate, time-continuous semi-conductor component test is performed with it for the same semi-conductor component (3a).

2. A test system according to claim 1, in which only the functionality of the semi-conductor component (3a) is tested during the time-discrete semi-conductor component test.

3. A test system according to claim 2, in which the functionality of the semi-conductor component (3a) is tested thereby, that bits or bit sequences received from the semi-conductor component (3a) are compared with reference bits or bit sequences.

4. A test system according to claim 1, in which in the time-continuous semi-conductor component test the integrity and/or quality of the signals emitted by the semi-conductor component (3a) is tested.

5. A test system according to claim 4, in which the integrity and/or quality of the signals emitted by the semi-conductor component (3a) is tested by means of corresponding skew and/or pulse duty ratio distortions and/or ISI (inter-symbol interference) and/or jitter measurements.

6. A semi-conductor component test procedure, in particular one using a test system according to claim 1 which comprises the following steps:
Performing a time-discrete semi-conductor component test for a particular semi-conductor component (3a), in particular with a first test apparatus (6a); and
Performing a separate, time-continuous semi-conductor component test for the same semi-conductor component (3a), in particular with a separate second test apparatus (6b).

7. A process according to claim 6, whereby during the time-discrete semi-conductor component test only the functionality of the semi-conductor component (3a) is tested.

8. A process according to claim 7, whereby the functionality of the semi-conductor component (3a) is tested thereby that bits or bit sequences received from the semi-conductor component (3a) are compared with reference bits or bit sequences.

9. A process according to one, claim 6 whereby during the continuous semi-conductor component test only the integrity and/or quality of the signals emitted by semi-conductor component (3a) is tested.
